(19) United States
(12) Patent Application Publication
(10) Pub. No.: US 2006/0199585 A1
(43) Pub. Date: Sep. 7, 2006

(54) Classmark provision for terminal-initiated handover

(75) Inventors: Pasi Laitinen, Oulu (FI); Hannu Huusko, Oulu (FI); Lars Dalsgaard, Oulu (FI)

Correspondence Address: SQUIRE, SANDERS & DEMPSEY L.L.P., 14TH FLOOR, 8000 TOWERS CRESCENT, TYSONS CORNER, VA, 22182, US

(73) Assignee: Nokia Corporation

(21) Appl. No.: 11/123,129

(22) Filed: May 6, 2005

Related U.S. Application Data
(60) Provisional application No. 60/656,892, filed on Mar. 1, 2005.

(51) Int. Cl. H04Q 7/20

(52) U.S. Cl. 455/436; 455/435.2

(57) ABSTRACT

A terminal device, network device and methods provide classmark information to an access network. The classmark information is added to a handover request message and signaled to the access network. Thereby, exchange of additional messages for keeping classmark information up-to-date is not required and it is ensured that the access network has the correct classmark information available in cases of terminal-initiated handovers.

### FIELD OF THE INVENTION

The present invention relates to a terminal device and a network device for providing access to an access network, and to methods of providing a classmark information to the access network. In particular, the present invention relates to a classmark provision for a terminal-initiated handover from an unlicensed access network (UMA) to a cellular network such as a GSM (Global System for Mobile communication) network.

### BACKGROUND OF THE INVENTION

Unlicensed Mobile Access (UMA) technology enables access to cellular mobile services, e.g. GSM, WCDMA (Wideband Code Division Multiple Access) or GPRS (General Packet Radio Services) over an unlicensed spectrum, including Bluetooth™ and WiFi™. The UMA technology enables seamless delivery of mobile voice and data services over unlicensed wireless networks. The same mobile identity is provided on cellular radio access networks and unlicensed wireless networks, so that seamless transitions (e.g. roaming and handover) between these networks is possible.

However, different cellular mobile stations (e.g. GSM mobile stations) have different characteristics. For several purposes, the cellular network (e.g. GSM or WCDMA network) needs to be aware of the characteristics of the mobile station when it is engaged in a circuit-switched (CS) connection with the network. As an example, the maximum transmission power of the mobile station is needed for preparation of handovers, i.e., channel changes during a connection. In GSM networks, the network is responsible for making the handover decision based on measurement reports sent regularly by the mobile station, i.e., the network implements the handover algorithm.

The UMA system can be connected to the GSM system so that handovers from the UMA network (UMAN) to the GSM network are possible. However, in the UMA network, the mobile station is responsible for indicating to the UMA network when a handover from the UMA network to the GSM is needed, i.e. the mobile station implements the handover algorithm. Hence, to achieve such an intersystem handover, the network needs to be aware of characteristic features of the mobile station, such as maximum transmission power.

In general, the mobile station indicates its characteristic features to the responsible network in a so-called mobile station classmark, e.g. a 32-bit information indicating the properties or characteristic features of the mobile station. However, the mobile station characteristics indicated in the mobile station classmark may change during an ongoing connection. For example, when a handheld mobile station is connected to a vehicle-mounted part including an RF (Radio Frequency) transmitter, the maximum transmission power of the mobile station may change depending on the capabilities of the transmitter.

The UMA Radio Resource (URR) protocol contains no mechanism or procedure for the mobile station to deliver the mobile station classmark to the network when the mobile station characteristics indicated in the mobile station classmark change during an ongoing connection. As a result, the network is not necessarily aware of characteristic features, such as the current maximum transmission power of the mobile station, when it prepares a handover from the UMA network to a cellular network, e.g. the GSM network. This may lead to inefficient utilization of resources in the UMA network and/or the GSM network, or even to handover failure. For example, when the network selects a cell where to transfer (handover) the connection, it may select a non-optimal cell as it is not aware of the radio frequency conditions in which the mobile station is currently capable of operating in.

According to the current UMA specification of the protocols (stage 3), version R1.0.2, section 7.1, a Classmark Interrogation Procedure is proposed, in which the UMA network may request the mobile station classmark from the mobile station anytime during a connection. However, this procedure requires sending of a request message from the UMA network to the mobile station, and a response message from the mobile station to the UMA network. Accordingly, with this classmark interrogation procedure, separate request and response messages have to be exchanged between the mobile station and the UMA network. At the time when a handover is needed, exchanging messages is not efficient as it would delay the execution of the handover itself, therefore possibly leading to a connection loss. Moreover, in handover conditions, uplink signal quality is usually far from good, so that delivery of the response message from the mobile station to the UMA network may not succeed.

FIG. 4 shows a schematic signaling diagram of the above mentioned conventional Classmark Interrogation Procedure as defined in the above UMA specification. When a connection between a mobile station and the UMA network has been established, the UMA network may send a request message, i.e. URR CLASSMARK ENQUIRY, to the mobile station. In response thereto, the mobile station responds with a URR CLASSMARK CHANGE message including the up-to-date mobile station classmark.

### SUMMARY OF THE INVENTION

It is therefore an object of the present invention to provide an improved system for classmark provision to the UMA network, by means of which availability of an up-to-date mobile station classmark can be ensured without the risk of handover failures.

This object is achieved by a method of providing classmark information to an access network, said method comprising the steps of:
adding said classmark information to a handover request message; and
transmitting said handover request message from a terminal device to the access network in response to a detection of a handover situation.

Furthermore, the above object is achieved by a method of obtaining a classmark information of a terminal device, said method comprising the steps of:
receiving at a network device a handover request message transmitted by the terminal device; and
extracting said classmark information from the handover request message.

Additionally, the above object is achieved by a terminal device for providing access to an access network, said terminal device comprising:
message generating means for adding a classmark information to a handover request message; and
signaling control means for transmitting said handover request message with said added classmark information to said access network in response to a detection of a handover situation.

Further, the above object is achieved by a network device for controlling a connection between a terminal device and an access network, said network device comprising:
receiving means for receiving from said terminal device a handover request message; and
extracting means for extracting from said received handover control message a classmark information specifying characteristic parameters of said terminal device.

Accordingly, the required classmark information is directly signaled from the terminal device to the access network in a handover request message, so that an up-to-date classmark information is available for each handover preparation. Due to the fact that the classmark information is directly added to the handover request message, no additional message exchange is required.

Further advantageous modifications are defined in the dependent claims.

### BRIEF DESCRIPTION OF THE DRAWINGS

The present invention will now be described based on a preferred embodiment with reference to the accompanying drawings in which:

FIG. 1 shows a schematic signaling diagram indicating classmark provision according to the preferred embodiment;

FIG. 2 shows a schematic block diagram of a terminal device according to the preferred embodiment;

FIG. 3 shows a schematic block diagram of a network device according to the preferred embodiment; and

FIG. 4 shows a schematic signaling diagram of a conventional classmark interrogation procedure according to the prior art.

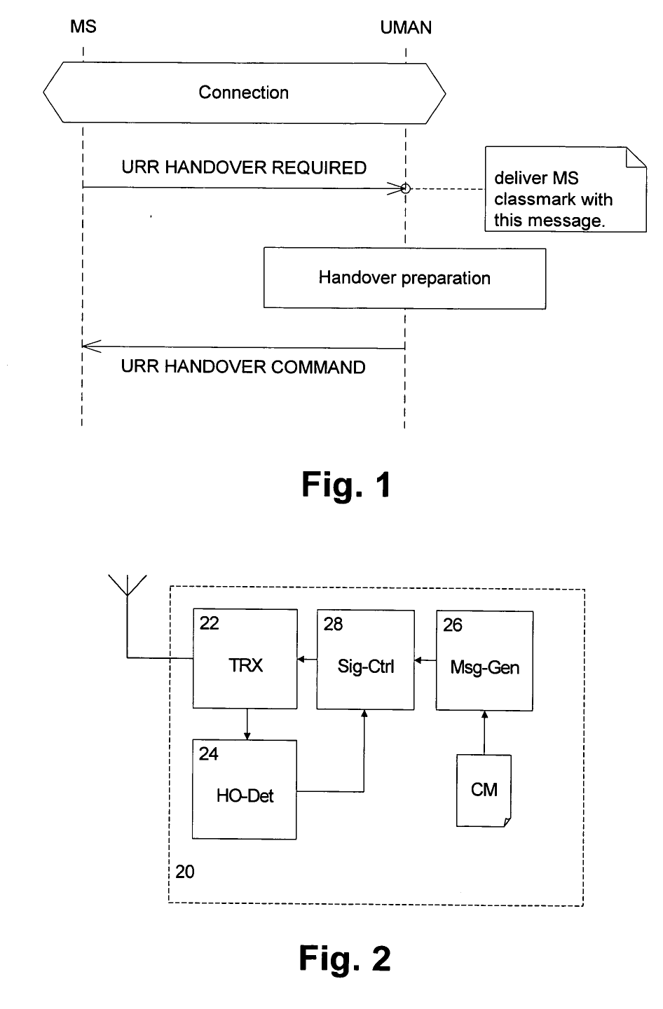

### DESCRIPTION OF THE PREFERRED EMBODIMENT

In the following, the preferred embodiment will be described in connection with a handover procedure between an UMA network and a GSM network.

According to the preferred embodiment, the mobile station classmark is added or incorporated, e.g. as information element, to a URR message HANDOVER REQUIRED and transmitted to the UMA network, in particular via the respective access point to a network controller (UNC) of the UMA network. Consequently, an up-to-date mobile station classmark is directly available for handover preparation at the UMA network, so that proper handover parameters can be selected. After the handover preparation, a URR message HANDOVER COMMAND is forwarded to the mobile station.

In an example of implementation it is suggested to add the fields:
mobile station classmark 2
mobile station classmark 3
   to the URR HANDOVER REQUIRED message. This could be implemented in the following way:

The MS triggers the handover from UMAN procedure indicating the list of cell identifiers in the target radio access technology. The message is directed from the mobile station to the S-UNC (Serving—UMA Network Controller).

The following table indicates an example of a content of an URR HANDOVER REQUIRED message, based on the above mentioned UMA specification:

| IEI | Information Element | Type/Reference | Presence | Format | Length | Value |
|---|---|---|---|---|---|---|
| | Length | Length | M | V | 2 | |
| | Indicator | Indicator | | | | |
| | UMA RR Protocol | Protocol Discriminator | M | V | ½ | 0001 |
| | Discriminator | | | | | |
| | Skip Indicator | Skip Indicator | M | V | ½ | 0000 |
| | URR HANDOVER | Message Type | M | V | 1 | |
| | REQUIRED message | | | | | |
| | identity | | | | | |
| 15 | Cell Identifier List | Cell Identifier | M | TLV | | |
| | | List | | | | |
| 28 | Mobile Station | Mobile Station | M | TLV | 5 | |
| | Classmark 2 | Classmark 2 | | | | |
| 56 | Additional Mobile | Mobile Station | C | TLV | 3-14 | |
| | Station Classmark | Classmark 3 | | | | |
| | Information | | | | | |

In the URR HANDOVER REQUIRED message, the fields Mobile Station Classmark 2 (see UMA stage 3 specification, section 11.2.28) and Additional Mobile Station Classmark Information (see UMA stage 3 specification, section 11.2.56) are classmark information fields according to this invention. The abbreviations “M” and “C” stand for “Mandatory” and “Conditional” and describe the presence of the information in the message. The abbreviation “TLV” and the Information Element Identifier (IEI) describe the encoding of the information in more detailed level according to the above mentioned UMA specification, section 11.1.4.

The new classmark provision according to the preferred embodiment does not suffer from the exchange of separate request and response messages between the mobile station and the UMA network at the time when a handover is needed. Still, it is ensured that the UMA network has an up-to-date mobile station classmark for handover preparation. In general, the proposed scheme is suitable for access networks, in which handovers are initiated by mobile stations or other terminal devices.

FIG. 2 shows a schematic block diagram of a terminal device, e.g. mobile phone, in which the proposed classmark provision functionality according to the preferred embodiment is implemented. Signaling data is transmitted and received by a transceiver unit 22 which is controlled by a signaling control unit 28 so as to transmit signaling messages, e.g. URR messages, generated by a message generation function or unit 26. This message generating unit 26 also adds the mobile station classmark CM to the respective URR HANDOVER REQUIRED message. The classmark CM may be generated in the message generation unit 26 or may be supplied from another processing function or unit of the terminal device 20.

Furthermore, a handover detection function or unit 24 is provided which detects a handover situation based on the signals received by the transceiver 22. In response to the detection of a handover situation, the handover detection unit 24 controls the signaling control unit 28 to transmit the URR HANDOVER REQUIRED message with the incorporated classmark to the UMA network via the transceiver 22.

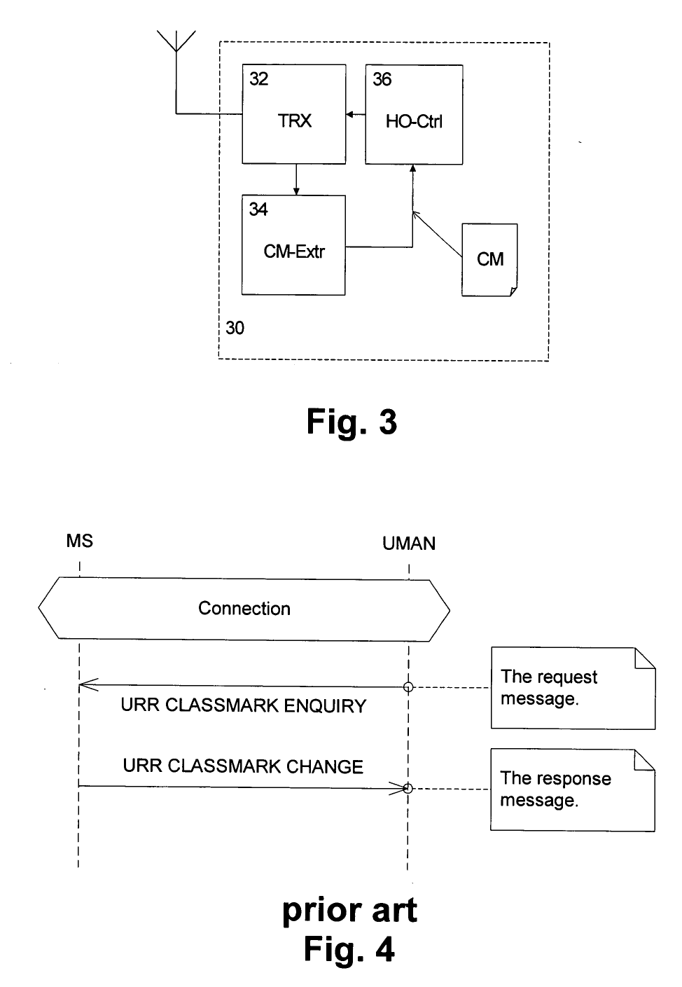

FIG. 3 shows a schematic block diagram of a network device 30, such as a network controller of the UMA network, e.g. S-UNC, in which the classmark provision functionality according to the preferred embodiment is implemented. Similar to the terminal device 20, the network device 30 comprises a transmitter 32 for transmitting and receiving signaling data. A classmark extraction function or unit 34 is provided which processes a URR HANDOVER REQUIRED message and detects and extracts the mobile station classmark CM which is then provided to a handover control function or unit 36 responsible for handover preparation and generation of the URR HANDOVER COMMAND message.

It is noted that the functions or units of the terminal device 20 and the network device 30 as shown in FIGS. 2 and 3 may be implemented as software routines which are configured to run a computer device or processor device provided in the terminal device 20 or the network device 30. As an alternative, the units or function as indicated by the blocks of FIG. 3 and 4 may be implemented as discrete hardware circuits.

Furthermore, it is to be noted that the present invention is not restricted to the above preferred embodiment and can be implemented in any terminal device or other wireless communication device connected to a network supporting a terminal-initiated handover procedure. Moreover, any kind of handover request message could be used depending on the cellular access network for adding and signaling the classmark information. The preferred embodiments may thus vary within the scope of the attached claims.

1. A method of providing classmark information to an access network, said method comprising the steps of:
adding classmark information to a handover request message; and
transmitting said handover request message from a terminal device to an access network in response to detection of a handover situation.

2. A method according to claim 1, wherein said handover request message comprises a message of an unlicensed mobile access (UMA) radio resource protocol.

3. A method according to claim 1, wherein said classmark information indicates characteristics of said terminal device.

4. A method according to claim 1, wherein said access network comprises an unlicensed mobile access network.

5. A method according to claim 4, wherein said handover situation comprises a handover from said unlicensed mobile access network to a cellular network.

6. A method according to claim 5, wherein said cellular network comprises at least one of a global system for mobile communications (GSM) and a wideband code division multiple access (WCDMA) network.

7. A computer program embodied on a computer-readable medium, the computer program configured to control a computer device to perform the steps of:
adding classmark information to a handover request message; and
transmitting said handover request message from a terminal device to an access network in response to detection of a handover situation.

8. A method of obtaining classmark information of a terminal device, said method comprising the steps of:
receiving, at a network device, a handover request message transmitted by a terminal device; and
extracting classmark information from said handover request message.

9. A method according to claim 8, wherein said network device comprises a network controller of an unlicensed mobile access network.

10. A method according to claim 9, wherein said handover situation comprises a handover from said unlicensed mobile access network to a cellular network.

11. A method according to claim 10, wherein said cellular network comprises at least one of a global system for mobile communication (GSM) and a wideband code division multiple access (WCDMA) network.

12. A method according to claim 10, wherein said handover request message comprises a message of an unlicensed mobile access (UMA) radio resource protocol.

13. A computer program embodied on a computer-readable medium, the computer program configured to control a computer device to perform the steps of:
receiving, at a network device, a handover request message transmitted by a terminal device; and
extracting classmark information from said handover request message.

14. A terminal device for providing access to an access network, said terminal device comprising:
message generating means for adding classmark information to a handover request message; and
signaling control means for transmitting said handover request message with said classmark information to an access network in response to detection of a handover situation.

15. A terminal device according to claim 14, wherein said handover request message comprises a message of an unlicensed mobile access (UMA) radio resource protocol.

16. A terminal device according to claim 14, wherein said access network comprises an unlicensed mobile access network.

17. A terminal device according to claim 16, wherein said handover situation comprises a handover from said unlicensed mobile access network to a cellular network.

18. A terminal device according to claim 17, wherein said cellular network comprises a global system for mobile communication (GSM) network.

19. A mobile phone for providing access to an access network, said mobile phone comprising:
message generating means for adding classmark information to a handover request message; and
signaling control means for transmitting said handover request message with said classmark information to said access network in response to detection of a handover situation.

20. A network device for controlling a connection between a terminal device and an access network, said network device comprising:
receiving means for receiving, from a terminal device, a handover request message; and
extracting means for extracting, from said handover request message, classmark information specifying characteristic parameters of said terminal device.

21. A network device according to claim 20, wherein said handover request message comprises a message of an unlicensed mobile access (UMA) radio resource protocol.

22. A network device according to claim 21, wherein said handover situation comprises a handover from said unlicensed mobile access network to a cellular network.

23. A network device according to claim 22, wherein said cellular network comprises at least one of a global system for mobile communication (GSM) and a wideband code division multiple access (WCDMA) network.

24. A network controller for controlling a connection between a mobile phone and an access network, said network controller comprising:
receiving means for receiving a handover request message from a mobile phone; and
extracting means for extracting, from said handover request message, classmark information specifying characteristic parameters of said mobile phone.
